(19) United States
(12) Patent Application Publication
(10) Pub. No.: US 2019/0178450 A1
(43) Pub. Date: Jun. 13, 2019

(54) Integrated Temperature and Pressure Reducing Device

(71) Applicant: WUZHONG INSTRUMENT CO., LTD., Wuzhong (CN)

(72) Inventors: Xuepeng WANG, Wuzhong (CN); Yuanbing LI, Wuzhong (CN); Peiran BAO, Wuzhong (CN); Yuanliang LI, Wuzhong (CN); Weixin CAl, Wuzhong (CN); Jianqiang CHEN, Wuzhong (CN)

(21) Appl. No.: 16/088,379

(22) PCT Filed: Dec. 27, 2016
(86) PCT No.: PCT/CN2016/112269

§ 371 Date: Sep. 25, 2018

(30) Foreign Application Priority Data
Mar. 25, 2016 (CN) 201610176529.8

(51) Int. Cl. F17D 1/06; F22G 5/12; F16K 47/08

(52) U.S. Cl. CPC F17D 1/06; F16L 55/02; F16K 47/08; F22G 5/12

(57) ABSTRACT

An integrated pressure and temperature reducing device, comprising a secondary steam pipe and a temperature and pressure reducing mechanism arranged within the secondary steam pipe; the temperature and pressure reducing mechanism comprises an upper valve cover and a spool; the spool is provided with a plurality of pressure reducing holes, and a valve stem is inserted at one end of the spool; an end of the valve stem which is close to the spool is provided with a water supply passage, an outer peripheral surface of the valve stem is provided with a plurality of water inlet holes which are in communication with the water supply passage; the other end of the spool is inserted with a temperature reducing water pipe, and an end of the temperature reducing water pipe which is close to the valve stem is provided with a water outlet passage.

### CROSS REFERENCE OF RELATED APPLICATION

The present application is a national phase application of International patent application PCT/CN2016/112269 filed Dec. 27, 2016, which claims priority to Chinese patent application 201610176529.8 filed Mar. 25, 2016, all of which are incorporated by reference herein in their entirety.

### TECHNICAL FIELD

The present disclosure relates to the field of valve manufacturing technology, and more particularly, to an integrated pressure and temperature reducing device.

### BACKGROUND

Pressure and temperature reducing devices are steam and thermal energy parameter conversion devices and energy-saving devices utilizing waste heat, which are widely used in combined heat and power generation, centralized heating or steam supplying in modern industry as well as used by light industry enterprises, power enterprises, chemical enterprises, textile enterprises and so on in thermal energy engineering. The pressure and temperature reducing devices decrease steam parameters provided by a user to temperature and pressure desired by the user in order for meeting the requirements of the user, thus heat energy can be fully saved and reasonably used.

A contact area between temperature reducing water and primary steam of the conventional pressure and temperature reducing device is small, which affects the pressure and temperature reducing effect, and results in inaccurate temperature control and slow reaction. The temperature reducing is realized by atomization, warming up, and vaporization of the temperature reducing water in a temperature reducing apparatus. The conventional pressure and temperature reducing device has a large installation space, the input of the primary steam and the output of secondary steam are performed in a horizontal direction, and the pressure and temperature reducing device is vertically installed between the primary steam and the secondary steam.

### SUMMARY

The technical problem to be solved by the present disclosure is to provide an integrated pressure and temperature reducing device in order to solve the problem that the contact area between the temperature reducing water and the primary steam of the conventional pressure and temperature reducing device is small.

The technical solution used by the present disclosure for solving the technical problem is as follows: an integrated pressure and temperature reducing device includes a secondary steam pipe and a temperature and pressure reduction mechanism disposed inside the secondary steam pipe, wherein the temperature and pressure reduction mechanism includes an upper valve cover and a valve core, which is provided thereon with a number of depressurization holes; a valve rod is disposed at one end of the valve core, and one end of the valve rod close to the valve core is provided with a water delivery channel, and the valve rod 9 is provided, on an outer circumferential surface thereof, with a number of water inlet holes in communication with the water delivery channel; a temperature reducing water pipe is disposed at the other end of the valve core, one end of the temperature reducing water pipe close to the valve rod is provided with a drainage pipe, which is in communication with the water delivery channel, and a number of drainage holes are provided on an outer circumferential surface of the temperature reducing water pipe at one end of the temperature reducing water pipe away from the valve core, the drainage holes are in communication with the drainage pipe. By introducing the temperature reducing water, temperature reduction and decompression are simultaneously performed, thereby increasing a contact area between the temperature reducing water and the primary steam, and ensuring an excellent temperature and pressure reduction effect.

In order to make the valve core have a better temperature and pressure reduction effect, the integrated pressure and temperature reducing device further includes a casing, wherein the casing is sleeved on the temperature reducing water pipe, and a cavity is formed between the temperature reducing water pipe and the casing; the casing is fixedly connected to the valve core; the depressurization holes include primary depressurization holes and secondary depressurization holes, wherein the primary depressurization holes are a number of first through holes opened on the valve core, and the secondary depressurization holes are second through holes opened on the valve core, and the second through holes are in communication with the cavity; when the valve core is at a small opening degree, the primary steam is mixed with the temperature reducing water after being cooled by a wall of the temperature reducing water pipe through the second through holes, in this way, a better temperature and pressure reduction effect will be achieved; and when the valve core is in a fully-open state, a portion of the primary steam is mixed with the temperature reducing water after being cooled due to the contact with the wall of the temperature reducing water pipe, and the other portion of the primary steam is decompressed by the valve core and directly enters to be mixed with the temperature reducing water.

Further, an annular groove, which is in communication with the second through hole, is provided on a contact surface between the valve core and the casing, and the casing is provided thereon with a third through hole, which is in communication with the annular groove, and also in communication with the cavity.

In order to better control the temperature reducing water, further, the upper valve cover is slidably disposed on the valve core and the valve rod to match them. Because the upper valve cover is slidably disposed on the valve core and the valve rod to match the valve core and the valve rod, the upper valve cover may control a flow rate of the temperature reducing water entering the valve core, and thus the temperature reducing water can be supplied according to demand

In order to reduce an installation space of the device, further, the secondary steam pipe is provided with a primary steam pipe perpendicular thereto, an actuator is fixedly connected to one end of the secondary steam pipe, a temperature reducing water delivery apparatus is fixedly connected to the actuator, and one end of the temperature and pressure reduction mechanism is fixedly connected to the executing device, which changes an installation manner of an original integrated temperature and pressure reducing valve, improves temperature regulation accuracy of the temperature and pressure reducing valve, and also reduces the installation space of the entire device to make the structure more compact.

In order to fix the casing and the valve core securely and reliably, further, the casing is thermally assembled and fixed to the valve core, in this way, thermal assembly is adopted by the casing and the valve core, thereby, processing costs of component parts are reduced, materials are saved, and it is ensured that the casing and the valve core are fixed securely and reliably.

In order to allow the valve rod and the temperature reducing water pipe to operate stably and reliably, further, a metal gasket is disposed on a contact surface between the valve rod and the temperature reducing water pipe, and the metal spacer is also provided on the valve rod between the valve rod and the valve core, in this way, damage resulted from collision between the temperature reducing water pipe and the valve rod will be prevented, and it is ensured that the valve rod and the temperature reducing water pipe operate stably and reliably.

The advantageous effects of the present disclosure are as follows: when the integrated pressure and temperature reducing device of the present disclosure is in operation, by introducing the temperature reducing water, temperature reduction and decompression are simultaneously performed, thereby increasing the contact area between the temperature reducing water and the primary steam, and ensuring an excellent temperature and pressure reduction effect. When the valve core is at a small opening degree, the primary steam is mixed with the temperature reducing water after being cooled by the wall of the temperature reducing water pipe through the second through holes, in this way, a better temperature and pressure reduction effect will be achieved; and when the valve core is in a fully-open state, a portion of the primary steam is mixed with the temperature reducing water after being cooled due to the contact with the wall of the temperature reducing water pipe, and the other portion of the primary steam is decompressed by the valve core and directly enters to be mixed with the temperature reducing water. Because the upper valve cover is slidably disposed on the valve core and the valve rod to match the valve core and the valve rod, the upper valve cover may control a flow rate of the temperature reducing water entering the valve core, and thus the temperature reducing water can be supplied according to demand, which changes an installation manner of an original integrated temperature and pressure reducing valve, improves temperature regulation accuracy of the temperature and pressure reducing valve, and also reduces an installation space of the entire device to make the structure more compact. The casing is thermally assembled and fixed to the valve core, in this way, thermal assembly is adopted by the casing and the valve core, thereby, processing costs of component parts are reduced, materials are saved, and it is ensured that the casing and the valve core are fixed securely and reliably. The metal gasket is disposed on the contact surface between the valve rod and the temperature reducing water pipe, and the metal spacer is also provided on the valve rod between the valve rod and the valve core, in this way, damage resulted from collision between the temperature reducing water pipe and the valve rod will be prevented, and it is ensured that the valve rod and the temperature reducing water pipe operate stably and reliably. The present disclosure increases the contact area between the temperature reducing water and the primary steam, guarantees an excellent temperature and pressure reduction effect, achieves a high adjustment precision and obtains a compact structure.

### BRIEF DESCRIPTION OF THE DRAWINGS

Hereinafter, The present disclosure will be further described with reference to the accompanying drawings and embodiments.

FIG. 1 is a front view showing an integrated pressure and temperature reducing device according to the present disclosure;

FIG. 2 is a structural schematic diagram illustrating a temperature and pressure reducing mechanism of an integrated pressure and temperature reducing device according to the present disclosure;

FIG. 3 is a front view showing a temperature and pressure reducing mechanism of an integrated pressure and temperature reducing device according to the present disclosure;

FIG. 4 is a partial enlarged view of A in FIG. 3;

FIG. 5 is a structural schematic diagram illustrating an upper valve cover of an integrated pressure and temperature reducing device according to the present disclosure;

FIG. 6 is a structural schematic diagram illustrating a valve rod of an integrated pressure and temperature reducing device according to the present disclosure;

FIG. 7 is a structural schematic diagram illustrating a temperature reducing water pipe of an integrated pressure and temperature reducing device according to the present disclosure;

FIG. 8 is a structural schematic diagram illustrating a valve core of an integrated pressure and temperature reducing device according to the present disclosure;

FIG. 9 is a structural schematic diagram illustrating a casing of an integrated pressure and temperature reducing device according to the present disclosure.

In the drawings: 1. secondary steam pipe; 1-1. primary steam pipe; 2. actuator; 3. temperature reducing water delivery apparatus; 4. upper valve cover; 5. valve core; 6. casing; 7. first through hole; 8. second through hole; 9. valve rod; 9-1. water delivery channel; 9-2. water inlet hole; 10. temperature reducing water pipe; 10-1. drainage pipe; 10-2. drainage hole; 11. cavity; 12. annular groove; 13. third through hole; 14. metal gasket.

### DETAILED DESCRIPTION

The present disclosure will now be further described in detail with reference to the accompanying drawings. The drawings are simplified schematic diagrams, and are only illustrative of a basic structure of the present disclosure schematically, thus are only illustrative of constitutions related to the present disclosure.

### EMBODIMENT 1

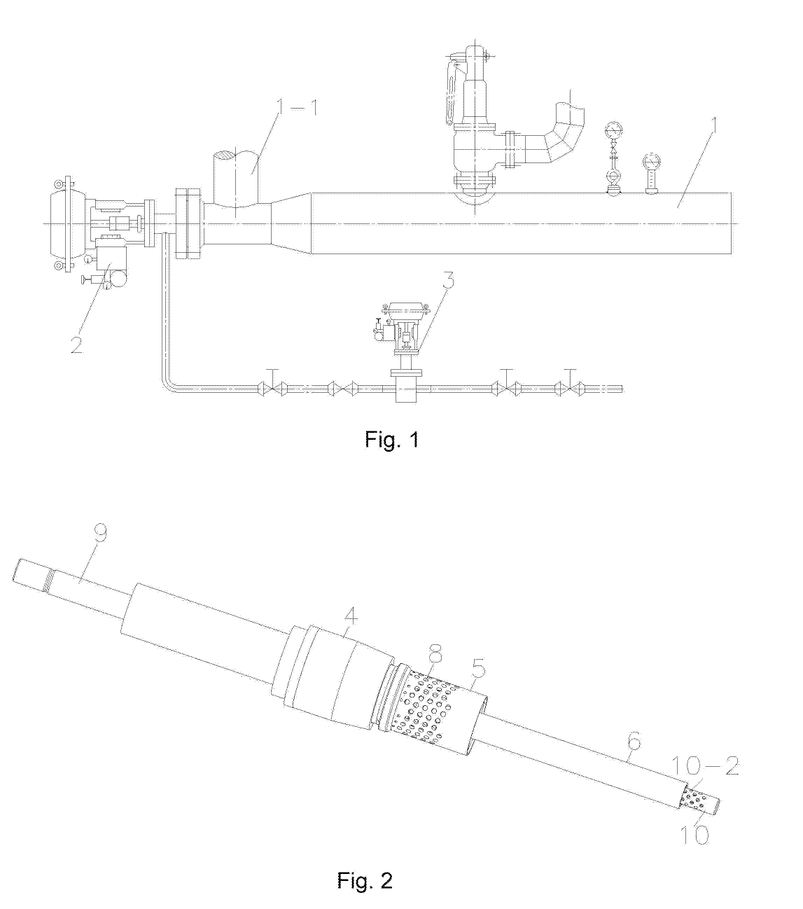

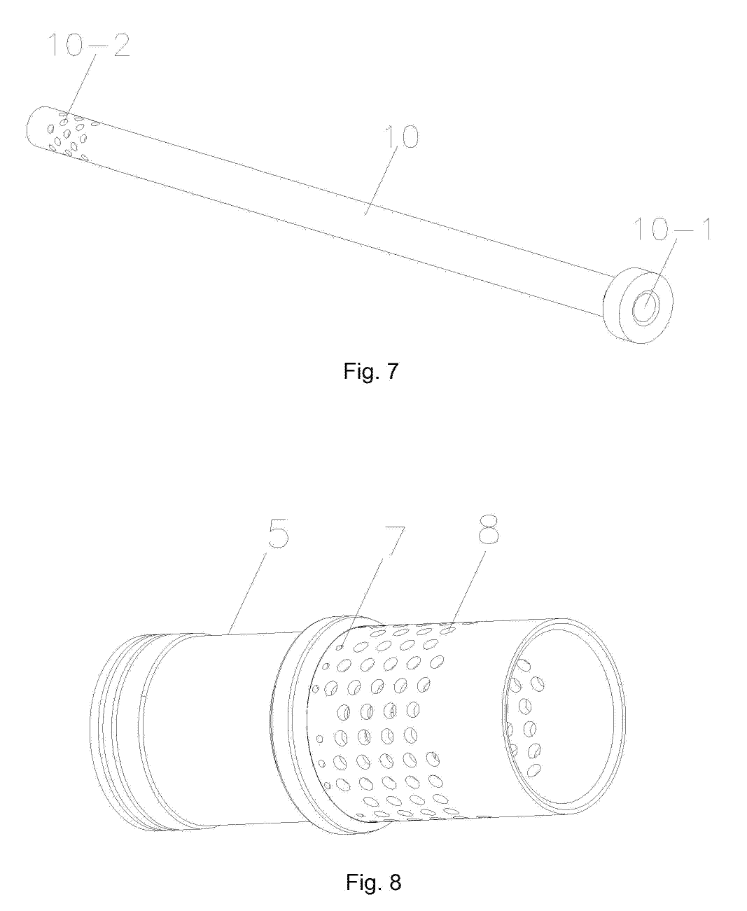

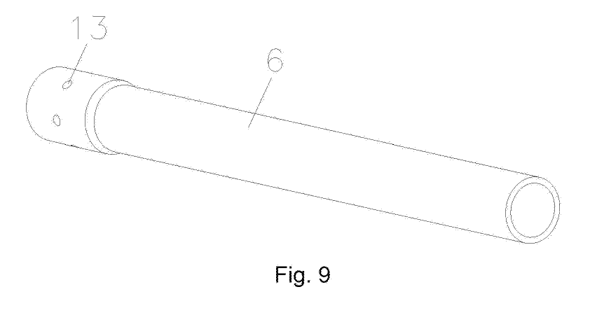

As shown in FIGS. 1, 2, 6, 7, 8 and 9, an integrated pressure and temperature reducing device includes a secondary steam pipe 1 and a temperature and pressure reduction mechanism disposed inside the secondary steam pipe 1. The temperature and pressure reduction mechanism includes an upper valve cover 4 and a valve core 5, which is provided thereon with a number of depressurization holes. A valve rod 9 is disposed at one end of the valve core 5, and one end of the valve rod 9 close to the valve core 5 is provided with a water delivery channel 9-1, and the valve rod 9 is provided, on an outer circumferential surface thereof, with a number of water inlet holes 9-2 in communication with the water delivery channel 9-1. A temperature reducing water pipe 10 is disposed at the other end of the valve core 5, one end of the temperature reducing water pipe 10 close to the valve rod 9 is provided with a drainage pipe 10-1, which is in communication with the water delivery channel 9-1, and a number of drainage holes 10-2 are provided on an outer circumferential surface of the temperature reducing water pipe 10 at one end of the temperature reducing water pipe 10 away from the valve core 5, the drainage holes 10-2 are in communication with the drainage pipe 10-1.

As shown in FIGS. 2, 3 and 4, the integrated pressure and temperature reducing device further includes a casing 6, wherein the casing 6 is sleeved on the temperature reducing water pipe 10, and a cavity 11 is formed between the temperature reducing water pipe 10 and the casing 6. The casing 6 is fixedly connected to the valve core 5. The depressurization holes include primary depressurization holes and secondary depressurization holes, wherein the primary depressurization holes are a number of first through holes 7 opened on the valve core 5, and the secondary depressurization holes are second through holes 8 opened on the valve core 5, and the second through holes 8 are in communication with the cavity 11.

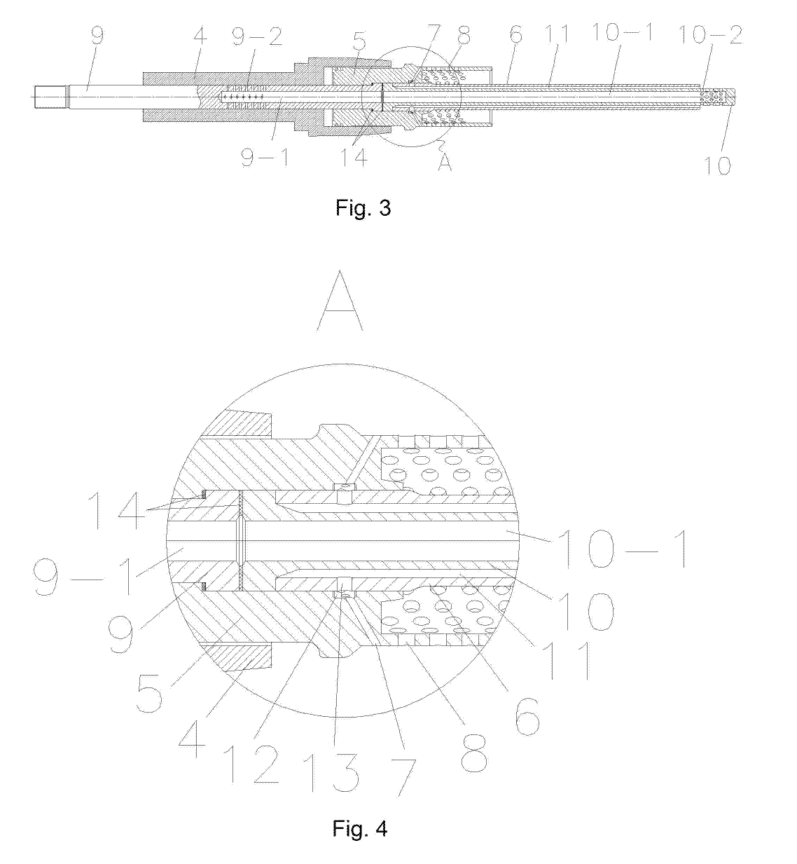

As shown in FIGS. 3 and 4, an annular groove 12, which is in communication with the second through hole 8, is provided on a contact surface between the valve core 5 and the casing 6. The casing 6 is provided thereon with a third through hole 13, which is in communication with the annular groove 12, and also in communication with the cavity 11.

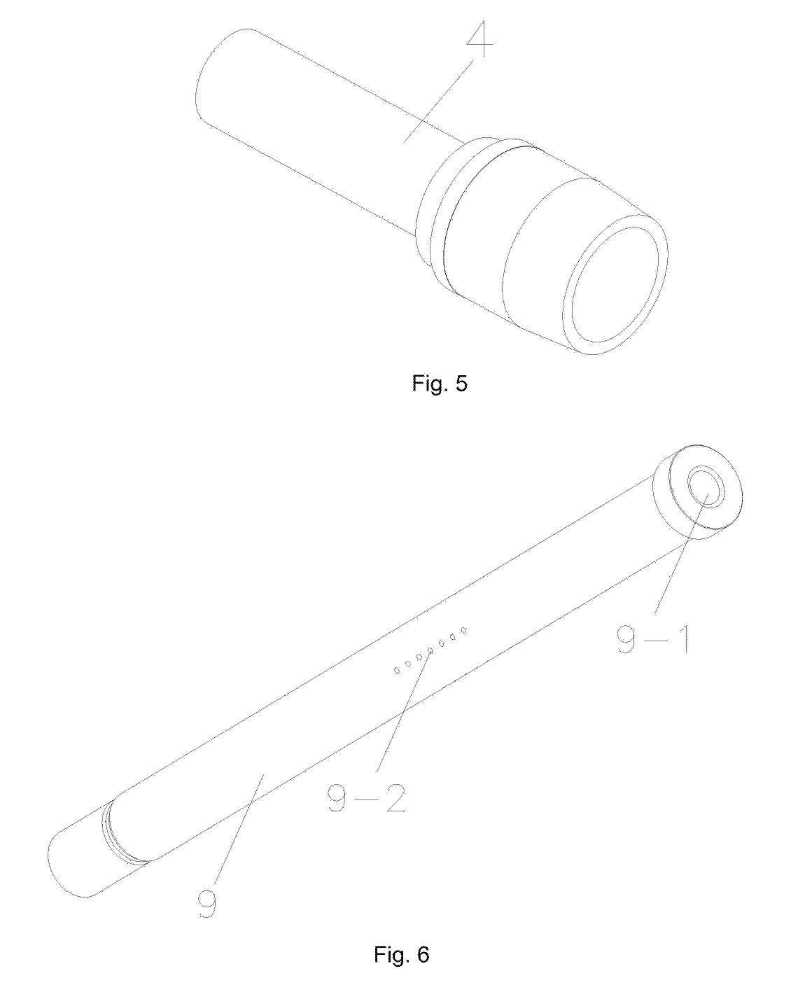

As shown in FIGS. 2, 3 and 5, the upper valve cover 4 is slidably disposed on the valve core 5 and the valve rod 9 to match them.

As shown in FIG. 1, the secondary steam pipe 1 is provided with a primary steam pipe 1-1 perpendicular thereto, an actuator 2 is fixedly connected to one end of the secondary steam pipe 1, a temperature reducing water delivery apparatus 3 is fixedly connected to the actuator 2, and one end of the temperature and pressure reduction mechanism is fixedly connected to the executing device 2.

The casing 6 is thermally assembled and fixed to the valve core 5.

As shown in FIGS. 3 and 4, a metal gasket 14 is disposed on a contact surface between the valve rod 9 and the temperature reducing water pipe 10, and the metal spacer 14 is also provided on the valve rod 9 between the valve rod 9 and the valve core 5.

When the above-described integrated pressure and temperature reducing device is in operation, first, the actuator 2 adjusts the valve rod 9, and adjusts the upper valve cover 4 to control the temperature reducing water. The temperature reducing water is inputted by the temperature reducing water delivery apparatus 3, and flows into the water delivery channel 9-1 of the valve rod 9 through the water inlet holes 9-2, and enters the drainage pipe 10-1 of the temperature reducing water pipe 10 from the water delivery channel 9-1, and then is discharged from the drainage holes 10-2; at the same time, primary steam is transported by the primary steam pipe 1-1, and an input amount of the primary steam is controlled by adjusting the valve core 5, when an opening degree of the valve core 5 is small, the primary steam is mixed with the temperature reducing water after being cooled by a wall of the temperature reducing water pipe 10, in this way, a better cooling effect can be achieved; and when the valve core 5 is in a fully-open state, a portion of the primary steam is mixed with the temperature reducing water after being cooled due to the contact with the wall of the temperature reducing water pipe 10, and the other portion of the primary steam is decompressed by the valve core 5 and directly enters to be mixed with the temperature reducing water. The secondary steam pipe 1 is provided with the primary steam pipe 1-1 perpendicular thereto, the actuator 2 is fixedly connected to one end of the secondary steam pipe 1, the temperature reducing water delivery apparatus 3 is fixedly connected to the actuator 2, and one end of the temperature and pressure reduction mechanism is fixedly connected to the executing device 2, which changes an installation manner of an original integrated temperature and pressure reducing valve, improves temperature regulation accuracy of the temperature and pressure reducing valve, and also reduces an installation space of the entire device to make the structure more compact. In view of the above-described embodiments of the present disclosure, various changes and modifications can be made by those skilled in the art without departing from the scope of the technical idea of the present disclosure. The technical scope of the present disclosure is not limited to the contents of the specification, and the technical scope thereof must be determined according to the scope of the claims.

What is claimed is:

1. An integrated pressure and temperature reducing device, comprising: a secondary steam pipe (1) and a temperature and pressure reduction mechanism disposed inside the secondary steam pipe (1), wherein
the temperature and pressure reduction mechanism comprises an upper valve cover (4) and a valve core (5), the valve core (5) is provided thereon with a number of depressurization holes;
a valve rod (9) is disposed at one end of the valve core (5), and one end of the valve rod (9) close to the valve core (5) is provided with a water delivery channel (9-1), and the valve rod (9) is provided, on an outer circumferential surface thereof, with a number of water inlet holes (9-2) in communication with the water delivery channel (9-1);
a temperature reducing water pipe (10) is disposed at the other end of the valve core (5), one end of the temperature reducing water pipe (10) close to the valve rod (9) is provided with a drainage pipe (10-1), which is in communication with the water delivery channel (9-1), and a number of drainage holes (10-2) are provided on an outer circumferential surface of the temperature reducing water pipe (10) at one end of the temperature reducing water pipe (10) away from the valve core (5), the drainage holes (10-2) are in communication with the drainage pipe (10-1).

2. The integrated pressure and temperature reducing device according to claim 1, further comprising: a casing (6), wherein the casing (6) is sleeved on the temperature reducing water pipe (10), and a cavity (11) is formed between the temperature reducing water pipe (10) and the casing (6);
the casing (6) is fixedly connected to the valve core (5);
the depressurization holes comprise primary depressurization holes and secondary depressurization holes, wherein the primary depressurization holes are a number of first through holes (7) opened on the valve core (5), and the secondary depressurization holes are second through holes (8) opened on the valve core (5), and the second through holes (8) are in communication with the cavity (11).

3. The integrated pressure and temperature reducing device according to claim 2, wherein an annular groove (12), which is in communication with the second through hole (8), is provided on a contact surface between the valve core (5) and the casing (6); and
the casing (6) is provided thereon with a third through hole (13), and the third through hole (13) is in communication with the annular groove (12) and also in communication with the cavity (11).

4. The integrated pressure and temperature reducing device according to claim 1, wherein the upper valve cover (4) is slidably disposed on the valve core (5) and the valve rod (9) fitted with the valve core (5) and the valve rod (9).

5. The integrated pressure and temperature reducing device according to claim 1, wherein the secondary steam pipe (1) is provided with a primary steam pipe (1-1) perpendicular thereto, an actuator (2) is fixedly connected to one end of the secondary steam pipe (1), a temperature reducing water delivery apparatus (3) is fixedly connected to the actuator (2), and one end of the temperature and pressure reduction mechanism is fixedly connected to the executing device (2).

6. The integrated pressure and temperature reducing device according to claim 3, wherein the casing (6) is thermally assembled and fixed to the valve core (5).

7. The integrated pressure and temperature reducing device according to claim 1, wherein a metal gasket (14) is disposed on a contact surface between the valve rod (9) and the temperature reducing water pipe (10), and the metal spacer (14) is also provided on the valve rod (9) between the valve rod (9) and the valve core (5).
